(19) United States
(12) Patent Application Publication
(10) Pub. No.: US 2023/0403058 A1
(43) Pub. Date: Dec. 14, 2023

(54) METHODS FOR WIRELESS COMMUNICATION IN HIGHER FREQUENCIES

(71) Applicant: INTERDIGITAL PATENT HOLDINGS, INC., Wilmington, DE (US)

(72) Inventors: Nazli Khan Beigi, Longueuil (CA); Young Woo Kwak, Woodbury, NY (US); Moon IL Lee, Melville, NY (US); Paul Marinier, Brossard (CA); Fumihiro Hasegawa, Westmount (CA)

(73) Assignee: INTERDIGITAL PATENT HOLDINGS, INC., Wilmington, DE (US)

(21) Appl. No.: 18/032,969

(22) PCT Filed: Oct. 22, 2021
(86) PCT No.: PCT/US2021/056283

§ 371 Date: Apr. 20, 2023

Related U.S. Application Data
(60) Provisional application No. 63/104,270, filed on Oct. 22, 2020.

(51) Int. Cl. H04B 7/06; H04B 17/318; H04L 5/00

(52) U.S. Cl. CPC H04B 7/0626; H04B 17/328; H04L 5/0048

(57) ABSTRACT

Methods and apparatuses for seamless switching between frequency ranges are provided herein. A method may include: receiving information identifying channel state information (CSI) reference signal (CSI-RS) resources in a first frequency range (FR), where each of the CSI-RS resources in the first FR is associated with CSI-RS resources in a second FR and the second FR is a lower FR than the first FR; and measuring a signal quality of at least one of the CSI-RS resources in the first FR. The method may further include selecting a subset of the CSI-RS resources in the first FR or the second FR, wherein, on a condition that the measured signal quality meets or exceeds a threshold, the selected subset is in the first FR, and the selection is based on the measured signal quality. The method may further include reporting the measured signal quality.

### CROSS-REFERENCE TO RELATED APPLICATIONS

This application claims the benefit of U.S. Provisional Application No. 62/104,270 filed Oct. 22, 2020; the contents of which are incorporated herein by reference.

### BACKGROUND

New studies for New Radio (NR) technologies using bands beyond 52.6 GHz are underway. These technologies may be a foundation for the future high data rate frameworks. However, the realization of systems using bands beyond 52.6 GHz may be subject to the resolution of key challenges raised by special channel and radiation characteristics of these bands. For instance, in bands beyond 52.6 GHz, delay spread may decrease with increasing carrier frequencies. Also, free-space attenuation may increase due to spreading loss and oxygen absorption. As such, multipath channel components may be suppressed due to narrow beamforming.

Moreover, the use of highly directional antennas in beyond-52.6 GHz systems may imply a high sensitivity to antenna misalignment and dynamic line-of-sight (LOS) blockage. Thus, reliance on channel models with line-of-sight (LOS) or specular reflections may be considered a key challenge in realizing reliable connections in beyond-52.6 GHz systems.

With increases in the scale of networks, beyond-52.6 GHz systems may be great candidates for implementing small cells (e.g., femtocells and picocells) and heterogeneous networks. The hierarchical framework in such networks may enable the aggregation of cells with different attributes such as different frequency ranges. Hence, subsets of nodes may merge or separate from cells with different frequency ranges dynamically and based on the quality of a channel's connection.

The impressive features provided by heterogenous networks with hierarchical spatial relations, in conjunction with existing challenges posed by beyond-52.6 GHz may be a basis for the concepts disclosed herein. For example, methodologies for seamless switching between different frequency ranges (FRs) are proposed, in which nodes with beyond-52.6 GHz capabilities may switch to lower FRs in the case of poor channel conditions, e.g., non-line of sight (NLOS).

### SUMMARY

Methods and apparatuses for seamless switching between frequency ranges are provided herein. A method may include: receiving information identifying channel state information (CSI) reference signal (CSI-RS) resources in a first frequency range (FR), where each of the CSI-RS resources in the first FR is associated with CSI-RS resources in a second FR and the second FR is a lower FR than the first FR; and measuring a signal quality of at least one of the CSI-RS resources in the first FR. The method may further include selecting a subset of the CSI-RS resources in the first FR or the second FR, wherein, on a condition that the measured signal quality meets or exceeds a threshold, the selected subset is in the first FR, and the selection is based on the measured signal quality. The method may further include reporting the measured signal quality.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 depicts an example system in accordance with one or more embodiments disclosed herein;

FIG. 3 depicts an example of a system in which CSI-RS resources belonging to different FRs are associated with one another;

FIG. 4 depicts an example of a system in which signals transmitted in different FRs share a spatial relationship;

FIG. 5 depicts an example of a system supporting seamless switching between FRs;

FIG. 6 is a flowchart depicting an example of a method for seamless switching between FRs as may be performed by a WTRU;

FIG. 7 shows an example of Quasi Co-Location (QCL) relationship information for a resource set; and

FIG. 8 shows an example of spatial relationship information for a resource set.

### DETAILED DESCRIPTION

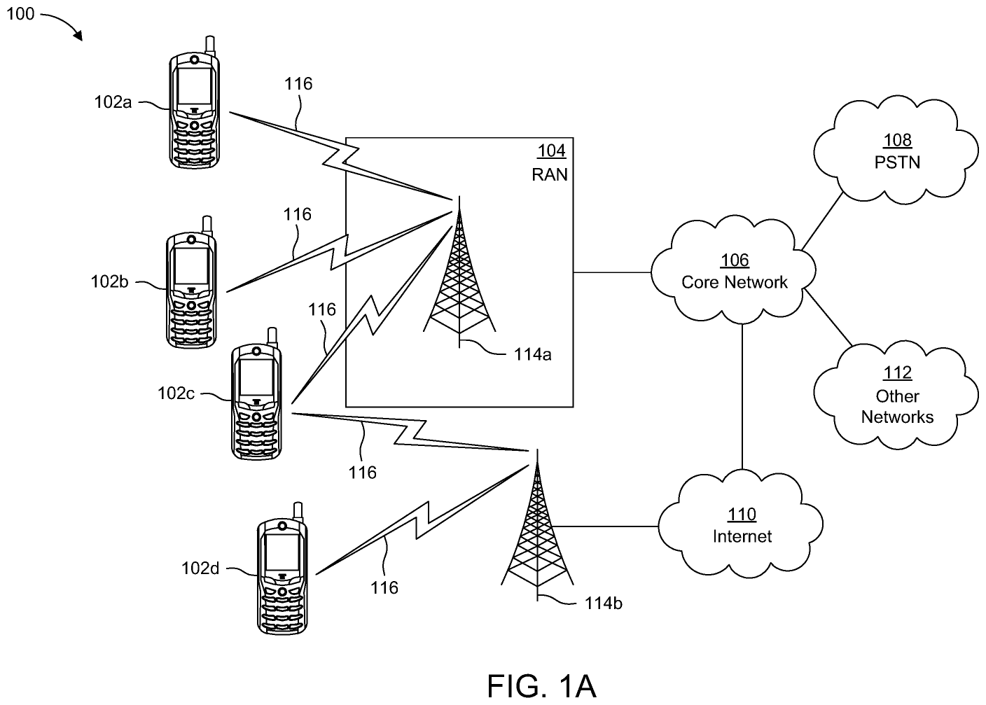

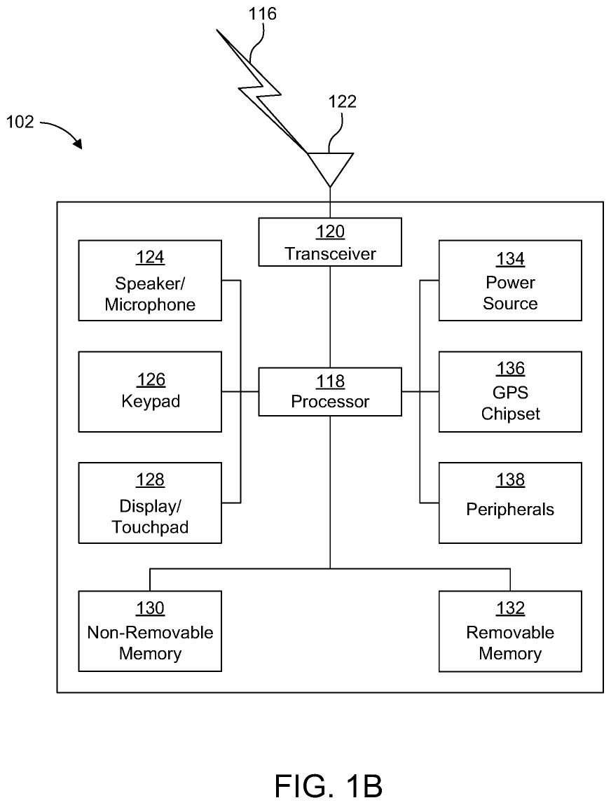

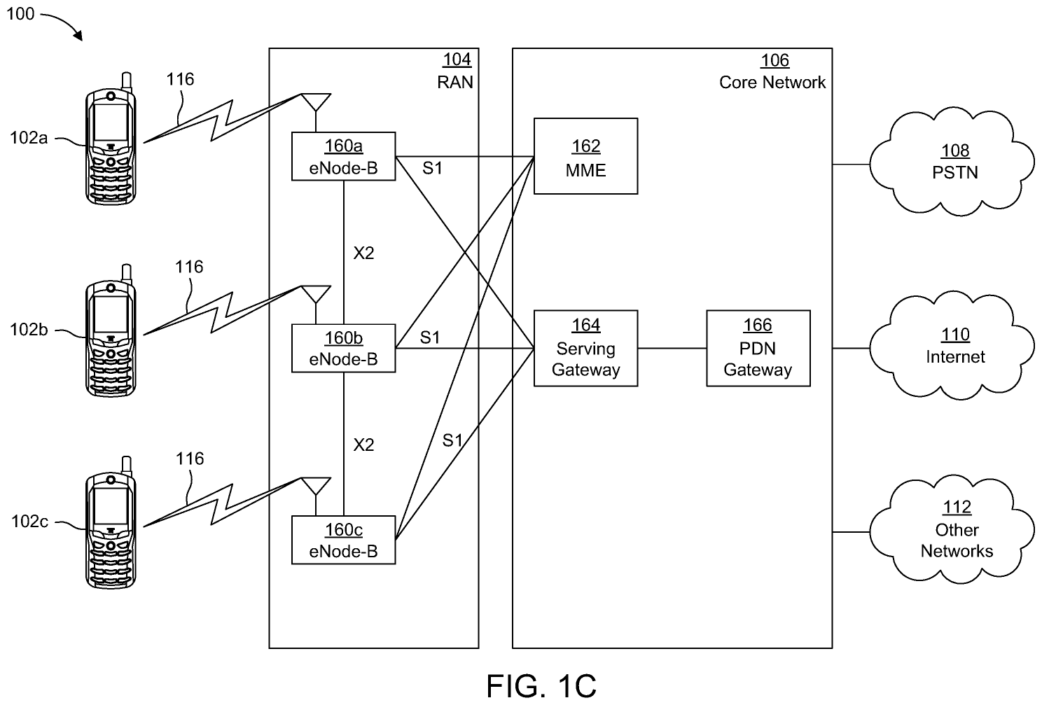

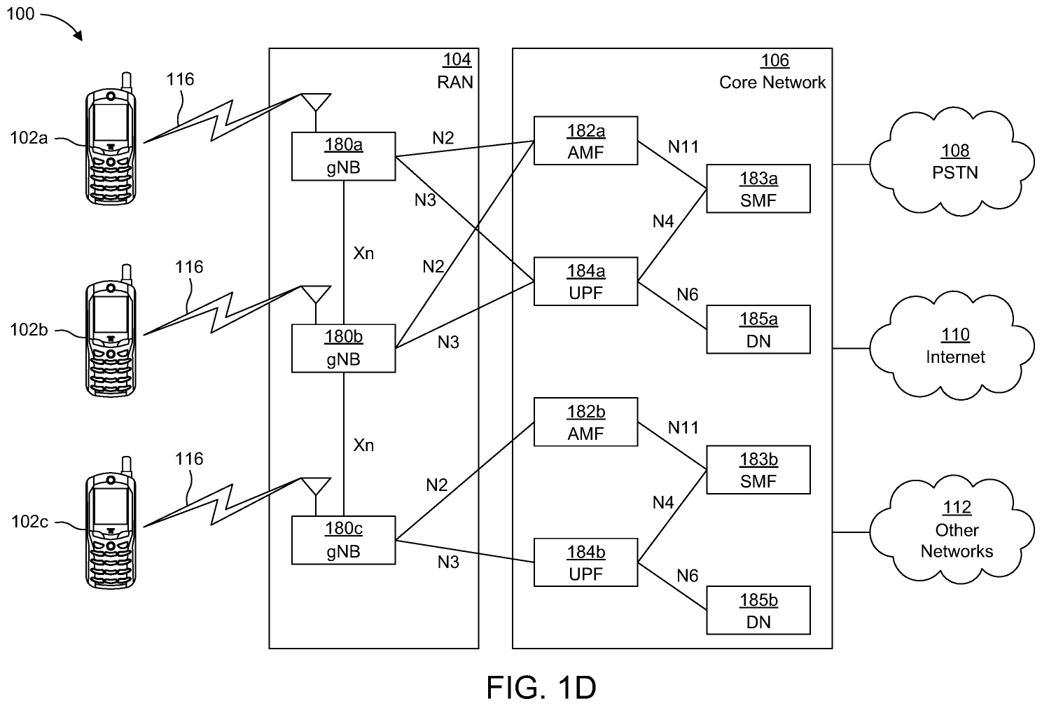

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 10 is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

One problem that may be addressed by the solutions described herein may be how the WTRU remains connected and performs reliably in poor channel conditions (NLOS), when communicating in higher frequencies. In the higher frequency ranges, e.g., in frequency bands beyond 52.6 GHz, a Line of Sight (LOS) blockage may drastically impact the wireless connection's quality and reliability. This may be mitigated in heterogenous networks, where the cells may have different attributes such as different frequency ranges (FR). Hence, in case of a node with beyond 52.6 GHz band that has encountered a LOS blockage, the affected node may switch dynamically to lower FRs.

Seamless switching between FRs in networks with hierarchical spatial relations may necessitate several enhancements. For instance, Quasi Co-Location (QCL), Transmission Configuration Indicator (TCI) states and spatial relationships updates, in addition to latency and Control Resource Set (CORESET) or Channel State Information Reference Signal (CSI-RS) associations may be considered.

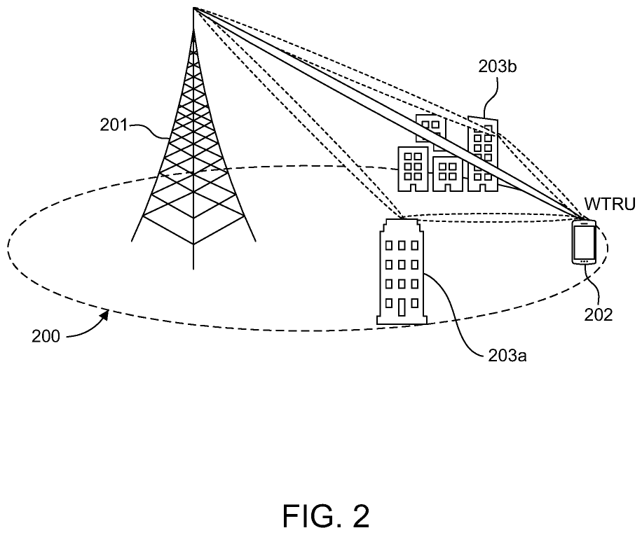

FIG. 2 depicts an example system in accordance with one or more embodiments described herein. The system may include a network node, e.g. a nodeB (which may also be referred to herein as a base station, a fifth generation nodeB (gNB), or a transmit/receive point (TRP) thereof) 201 and a WTRU 202. The WTRU 202 may be within a cell 200, which is served by the nodeB 201. The WTRU 202 may be configured to communicate, e.g., to send and receive transmissions to and from the nodeB 201. The WTRU 202 and the nodeB 201 may be communicating over higher frequencies (e.g., 52.6 GHz and beyond). One or more obstructions (denoted in FIG. 2 by 203a and 203b) may be present within the cell 200. The presence of obstructions in the area between the WTRU 202 and the nodeB 201 may affect the propagation of radio waves in the system. For example, non-line-of-sight (NLOS), or blockage of signals between the nodeB 201 and the WTRU 202 may occur due to due the presence of the obstructions 203a or 203b. Additionally, certain characteristics of higher frequency range communication such as delay spread, free-space attenuation, and the suppression of channel multipath components may prove detrimental to connection quality and reliability. On the other hand, reflection of signals off of the obstructions 203a or 203b may also occur. In some implementations, a system may utilize intelligent reflective surfaces to harness reflections off of passive elements and to achieve LOS by beamforming. Thus, channel conditions may be highly variable depending on the environment and frequency range used.

Embodiments for CSI-RS PMI reporting in association with FRs may be understood within the context of FIG. 2. Some embodiments as may be further discussed herein may concern CSI reporting based on a preferred frequency range (FR). In such embodiments, a WTRU may receive CSI report configuration information that indicates a first CSI report metric (e.g., a CSI Resource Indicator (CRI), Rank Indicator (RI), Layer Indicator (LI), Precoding Matrix Indicator (PMI), or Channel Quality Information (COI)) associated with a CSI Resource Setting in a first FR (e.g., FR3) and a second CSI report metric (e.g., CRI, RI, PMI, CQI or CRI-RI-i1) associated with a CSI Resource Setting in a second FR (e.g., FR1 or FR2). The first CSI report metric may be associated with a first codebook configuration (e.g., a Type-I codebook) and the second CSI report quantity may be associated with a second codebook configuration (e.g., a Type-II codebook).

The WTRU may determine the FR(s) to be used, e.g., from the first FR and the second FR, based on the measurement of the first CSI-RS and the second CSI-RS. Based on the determined FR, the WTRU may report CSI to a nodeB. If the WTRU determines the first FR is to be used, the WTRU may report CSI based on the first CSI report quantity, the first codebook configuration, and the first CSI-RS. If the WTRU determines the second FR is to be used, the WTRU may report CSI based on the second CSI report quantity, the second codebook configuration, and the second CSI-RS.

In some embodiments, a CSI report may include three or more parts: a first part may include one or more indications of the FR to be used; a second part may include wideband information (e.g., one or more of CRI, RI, LI, wideband PMI, or wideband COI); and a third part may include subband information (e.g., a subband PMI and/or a subband CQI). Optionally, based on the FR indication, the WTRU may determine a FR of the first FR and the second FR. In some embodiments, the CSI report may contain fewer than three of the above-mentioned parts.

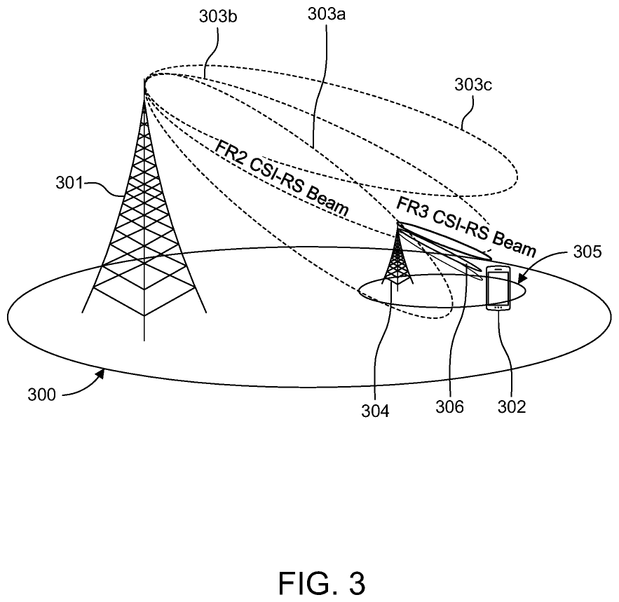

FIG. 3 depicts an example of a system in which CSI-RS resources belonging to different FRs are associated with one another. As shown in FIG. 3, the system may include a base station, e.g. a nodeB (e.g., a fifth generation nodeB (gNB)) 301 and a WTRU 302. The WTRU 302 may be within a cell 300, which is served by the nodeB 301. The WTRU 302 may be configured to communicate, e.g., to send and receive transmissions to and from the nodeB 301. The WTRU 302 and the nodeB 301 may be communicating over higher frequencies (e.g., 52.6 GHz and beyond), using a certain frequency range (e.g., FR2 as shown in FIG. 3).

Such communication may be performed using beamformed signals. For example, the nodeB may transmit signals using beams 303a, 303b, and 303c. In addition to sending data transmissions using the beams 303a, 303b, and 303c, the nodeB may also transmit CSI reference signals using each of the beams. The WTRU 302 may receive first configuration information for CSI reporting in accordance with the preceding paragraphs. The configuration information may include, for instance, one or more CSI-RS resource sets (e.g., for each of channel and interference measurements), and each CSI-RS resource set may include one or more CSI-RS resources. The CSI-RS resources may correspond, for instance, to the beams 303a, 303b, and 303c. The WTRU 302 may perform measurements of CSI reference signals corresponding to each of the beams 303a, 303b, and 303c.

The system 300 may further include at least one other network element 304 (which may be another nodeB or a remote radio head (RRH) associated with the nodeB 301). The network element 304 may also transmit beamformed signals in a given frequency range (e.g., FR3) that is different from the frequency range used by the nodeB 301. Hence, the network element 304 may establish a second cell 305, in which the WTRU 302 may also be present. The WTRU 302 may receive second configuration information for reporting CSI corresponding to beams 306, including one or more CSI-RS resource sets (e.g., for each of channel and interference measurements), and each CSI-RS resource set may include one or more CSI-RS resources. The CSI-RS resources may correspond, for instance, to the beams 306.

In accordance with the above paragraphs, the beam 303b of the first frequency range FR2 may be spatially directed in the area of network element 304 and/or the WTRU 302. The beams 306 of the network element 304 may also be spatially directed to the area of the WTRU 302. Hence, the beam 303b and the beams 306, and their corresponding CSI-RSs may be associated with one another. Based on the CSI reporting configurations, the WTRU may know the association between the CSI-RS resources for FR2 corresponding to beam 303b and the CSI-RS resources for FR3 corresponding to the beams 306. The WTRU 302 may know to perform measurements, at least of the CSI reference signals corresponding to the beams 306, based on the association of the CSI-RS resources of FR3 with the CSI-RS resources of FR2. As shown in FIG. 3, embodiments as may be discussed herein may concern CSI reporting for seamless switching between frequency ranges. In some embodiments, a WTRU may receive multiple CSI report configurations. For example, a WTRU may receive a first CSI report configuration for a first FR (e.g., FR2) and a second CSI report configuration for a second FR (e.g., FR3), associated with the first CSI report configuration. The second CSI report configuration may include one or more CSI-RS resource sets (e.g., for each of channel and interference measurements), and each CSI-RS resource set may include one or more CSI-RS resources. The first CSI report configuration may include a CSI-RS resource set (e.g., for each of channel and interference measurements), for instance, which may include one or more CSI-RS resources, and each CSI-RS resource may be associated with a CSI-RS resource set of the one or more CSI-RS resources of the second CSI report configuration.

The WTRU may receive a message or signal with information that triggers or activates both the first CSI report configuration and the second CSI report configuration. When the WTRU reports first CSI based on the first CSI report configuration, the WTRU may determine and report a CSI-RS resource based on measurements of the one or more CSI-RS resources indicated in the first CSI report configuration. When the WTRU reports second CSI based on the second CSI report configuration, the WTRU may determine and report a CSI-RS resource based on measurements of the one or more CSI-RS resources of the CSI-RS resource set associated with the CSI-RS resource of the first CSI.

Optionally, based on the first CSI and the second CSI, the WTRU may determine which of the first FR or the second FR to use. The WTRU may determine a FR by comparing a channel quality (e.g., CQI or L1-RSRP) of the first CSI and a channel quality of the second CSI.

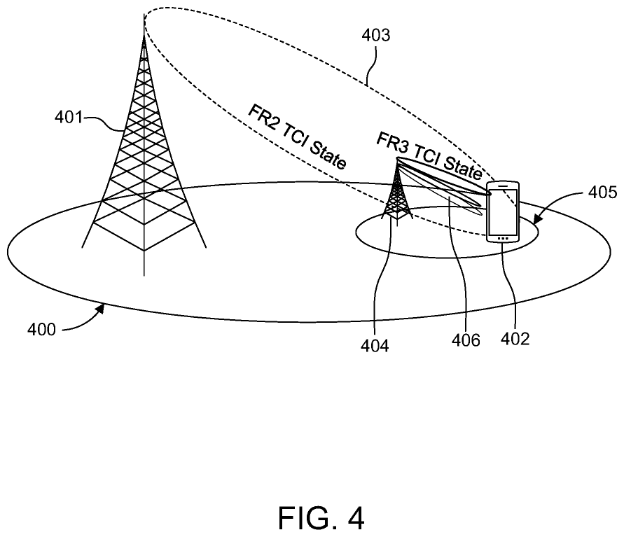

FIG. 4 depicts an example of a system in which signals transmitted in different FRs share a spatial relationship or, in other words, have associated TCI states. As shown in FIG. 4, the system may include a base station, e.g. a nodeB (e.g., a fifth generation nodeB (gNB)) 401 and a WTRU 402. The WTRU 402 may be within a cell 400, which is served by the nodeB 401. The WTRU 402 may be configured to communicate, e.g., to send and receive transmissions to and from the nodeB 401. The WTRU 402 and the nodeB 401 may be communicating over higher frequencies (e.g., 52.6 GHz and beyond), using a certain frequency range (e.g., FR2 as shown in FIG. 4). The system may further include at least one other network node 404 (which may be another nodeB or a remote radio head (RRH) associated with the nodeB 401). The network node 404 may also transmit signals in a given frequency range (e.g., FR3) that is different from the frequency range used by the nodeB 401. Hence, the network node 404 may establish a second cell 405, in which the WTRU 402 may also be present.

Signals transmitted by the nodeB 401 and the network node 404 may be beamformed signals. For example, transmissions between the nodeB 401 and the WTRU 402 may be performed using a beam 403, which may be associated with a given TCI state. The beam 403, as shown in FIG. 4, may be a wide beam. The WTRU 402 may receive configuration information indicating a first TCI state group for FR2, which may include the TCI state associated with the beam 403. The configuration information may further indicate a second TCI state group for FR3. The TCI states of the second TCI state group may be associated with narrow beams 406, which may also be associated with the wide beam 403. Hence, the FR3 TCI state group associated with the narrow beams 406 may be associated with at least one of the FR2 TCI states that corresponds to wide beam 403. The WTRU 402 may know, based on the received configuration information, to apply the first TCI state and the second TCI state for the first FR and the second FR, respectively.

As shown in FIG. 4, embodiments as may be discussed herein may concern hierarchical spatial relations for the seamless switching between the frequency ranges. For example, a WTRU may receive configuration information for a first TCI state group (e.g., beam groups for use in wide beam implementations) for a first FR (e.g., FR2) and second one or more TCI state groups (e.g., beam groups for use in narrow beam implementations) for a second FR (e.g., FR3). The first TCI state group may include one or more TCI states (e.g., for wide beam operation) and each TCI state, of the one or more TCI states, may be associated with a TCI state group of the second one or more TCI state groups. Each TCI state group of the second one or more TCI state groups may include one or more TCI states (e.g., for narrow beam operation).

The WTRU may receive an indication of a first TCI state for the first FR and an indication of a second TCI state for the second FR. The indication of the first TCI state may indicate a TCI state (e.g., wide beam indication) of the one or more TCI states of the first TCI state group. The indication of the second TCI state may indicate a TCI state of the one or more TCI states of the second TCI state group, associated with the first TCI state (e.g., narrow beam indication based on the indicated wide beam). The WTRU may apply the first TCI state and the second TCI state for the first FR and the second FR, respectively.

The term “beam” as is used throughout the present specification may be understood as follows. A WTRU may transmit or receive a physical channel transmission or a reference signal according to at least one spatial domain filter. The term “beam” may be used to refer to a spatial domain filter. The WTRU may transmit a physical channel or signal using the same spatial domain filter as the spatial domain filter used for receiving an RS (such as CSI-RS) or a Synchronization Signal (SS) block (SSB). The WTRU transmission may be referred to as a “target” transmission, and the received RS or SS block may be referred to as a “reference” or “source” transmission. In such case, the WTRU may be said to transmit the target physical channel or signal according to a spatial relation with reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”) transmission, respectively. In such cases, the WTRU may be said to transmit the first (target) physical channel or signal according to a spatial relation with reference to the second (reference) physical channel or signal.

A spatial relationship may be implicit, configured by RRC, signaled by a MAC Control Element (CE) or Downlink Control Information (DCI), or configured or signaled by any logical equivalent of such messages, information, or signals. For example, a WTRU may implicitly transmit PUSCH transmissions and a DM-RS of the PUSCH according to the same spatial domain filter as a Sounding Reference Signal (SRS) indicated by a SRS Resource Indicator (SRI) indicated in DCI, configured by RRC messaging, or provided by other logically equivalent means. In some examples, a spatial relationship may be configured, for example by RRC messaging for an SRI, or signaled by MAC CE for a PUCCH, or provided by any logical equivalent of the RRC messaging or MAC CE. An indication of such spatial relationship may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) type D assumption between corresponding antenna ports. Such association may be configured as a TCI (transmission configuration indicator) state. An indication of an association between a CSI-RS or SS block and a DM-RS may be conveyed to a WTRU by an index to a set of TCI states configured by RRC messaging and/or signaled by MAC CE. Such indication may also be referred to as a “beam indication”.

As may be further referenced and described herein, a grant or assignment may have one or more properties. Such properties may include, for example: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); or any parameter provided in a DCI, by MAC, by RRC, or by any other logical equivalent, for the scheduling the grant or assignment.

A property of the data included in a transport block (TB) may refer to any parameter configuring a logical channel or radio bearer for which data may be included in the TB. For example, at least one of a logical channel priority, prioritized bit rate, logical channel group, or an RLC mode. By extension, a property of a grant or assignment may also refer to a property of the data included in the corresponding TB.

In the following, an indication by DCI may include at least one of the following: an explicit indication by a DCI field or by RNTI used to mask a cyclic redundancy check (CRC) of the PDCCH; or an implicit indication by a property such as DCI format, DCI size, CORESET or search space, aggregation level, or a first resource element of the received DCI (e.g., index of first Control Channel Element), where the mapping between the property and the value may be signaled by RRC or MAC or any other logical equivalent.

Embodiments directed to CSI feedback enhancement for support of seamless switching between FRs are described herein. Some embodiments may address dependency in CSI-RS resources in association with the different FRs. A CSI report configuration (e.g., CSI-ReportConfigs) may be associated with a single BWP, e.g., indicated by BWP-Id. A WTRU may be configured with one or more of the following in a CSI report configuration: CSI-RS resources and/or CSI-RS resource sets for channel and interference measurement; a CSI-RS report configuration type such as periodic, semi-persistent, or aperiodic; a CSI-RS transmission periodicity for periodic and semi-persistent CSI reports; a CSI-RS transmission slot offset for periodic, semi-persistent and aperiodic CSI reports; a CSI-RS transmission slot offset list for semi-persistent and aperiodic CSI reports; time restrictions for channel and interference measurements; the thresholds and modes of calculations for the reporting quantities (CQI, RSRP, SINR, LI, RI, etc.); or the codebook configuration.

A CSI-RS Resource Set (e.g., a non-zero power (NZP) CSI-RS-ResourceSet) may include one or more CSI-RS resources (e.g., NZP-CSI-RS-Resource and CSI-ResourceConfig). A WTRU may be configured with one or more of the following in a CSI-RS Resource: a CSI-RS periodicity and slot offset for periodic and semi-persistent CSI-RS Resources; a CSI-RS resource mapping to define the number of CSI-RS ports, density, CDM-type, OFDM symbol, and subcarrier occupancy; the bandwidth part to which the configured CSI-RS is allocated; or the reference to the TCI-State including the QCL source RS(s) and the corresponding QCL type(s).

A WTRU may be configured with one or more CSI report configurations. Based on the one or more CSI report configurations, the WTRU may support independent CSI reports based on the one or more CSI report configurations (e.g., independent CSI reports). For example, the WTRU may be configured with a first CSI report configuration and a second CSI report configuration. The WTRU may report a first CSI report based on the first CSI report configuration and a second CSI report based on the second CSI report configuration.

The WTRU may also, or alternatively, support CSI reports based on associations among the one or more CSI report configurations (e.g., CSI reports based on associations). For example, the WTRU may be configured with a first CSI report configuration and a second CSI report configuration which is associated with the first CSI report configuration. The WTRU may report a first CSI report based on the first CSI report configuration and a second CSI report based on the first CSI report and the second CSI report configuration.

The associations of the CSI reports may be based on an association based on a nodeB indication. For example, a first CSI report configuration may be associated with a second FR following a nodeB (e.g., gNB) indication (e.g., by configuring an associated CSI report configuration ID).

The associations of the CSI reports may be additionally, or alternatively, based on associations between FRs. For example, a first CSI report configuration may be based on a first FR and a second CSI report configuration may be based on a second FR associated with the first FR. Based on the association, a WTRU may determine an association between the first CSI report configuration and the second CSI report configuration.

The associations of the CSI reports may be additionally, or alternatively, based on associations between BWPs. For example, a first CSI report configuration may be based on a first BWP and a second CSI report configuration may be based on a second BWP associated with the first BWP. Based on the association, a WTRU may determine an association between the first CSI report configuration and the second CSI report configuration

The associations of the CSI reports may be additionally, or alternatively, based on associations between CSI-RS resources/resource sets. For example, a first CSI report configuration may comprise a first one or more CSI-RS resources/resource sets and a second CSI report configuration may comprise a second one or more CSI-RS resources/resource sets associated with the first one or more CSI-RS resources/resource sets. Based on the association, a WTRU may determine an association between the first CSI report and the second CSI report. The CSI-RS resources/resource sets may be one or more CSI-RS resources/resource sets for channel measurements.

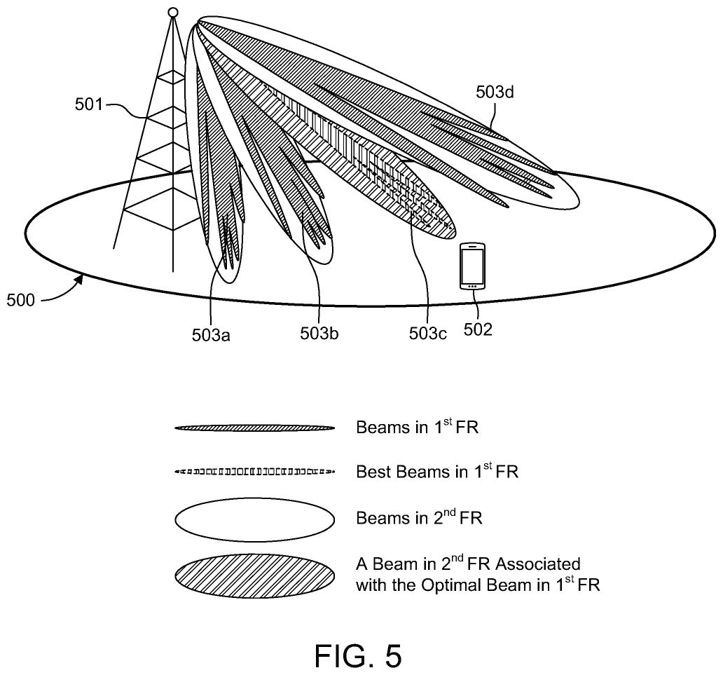

FIG. 5 depicts an example of a system supporting seamless switching between FRs. As shown in FIG. 5, the system may include at least a base station, e.g. a nodeB (e.g., a fifth generation nodeB (gNB)) 501 and a WTRU 502. The WTRU 502 may be within a cell 500, which is served by the nodeB 501. The WTRU 502 may be configured to communicate, e.g., to send and receive transmissions (e.g., both data and reference signals such as CSI-RS) to and from the nodeB 501. The nodeB 501 may be configured to transmit in multiple FRs (e.g., a first FR and a second FR) using beamforming. As shown in FIG. 5, the nodeB may transmit signals in the first FR using beams 503a, 503b, 503c, and 503d. Beams 503a, 503b, 503c, and 503d may be wide beams. Each of the wide beams 503a, 503b, 503c, and 503d may be associated with a set of narrow beams for transmission over a second FR. For communication with the WTRU 502, one of the wide beams, e.g., beam 503c, may be an optimal beam (e.g., a quality measurement associated with the beam 503c may be the highest of the quality measurements associated with all of the beams). A CSI-RS (or set of CSI-RSs) may be associated with each of the wide beams 503a, 503b, 503c, and 503d of the first FR. Another CSI-RS (or set of CSI-RSs) may be associated with each of the narrow beams of the second FR.

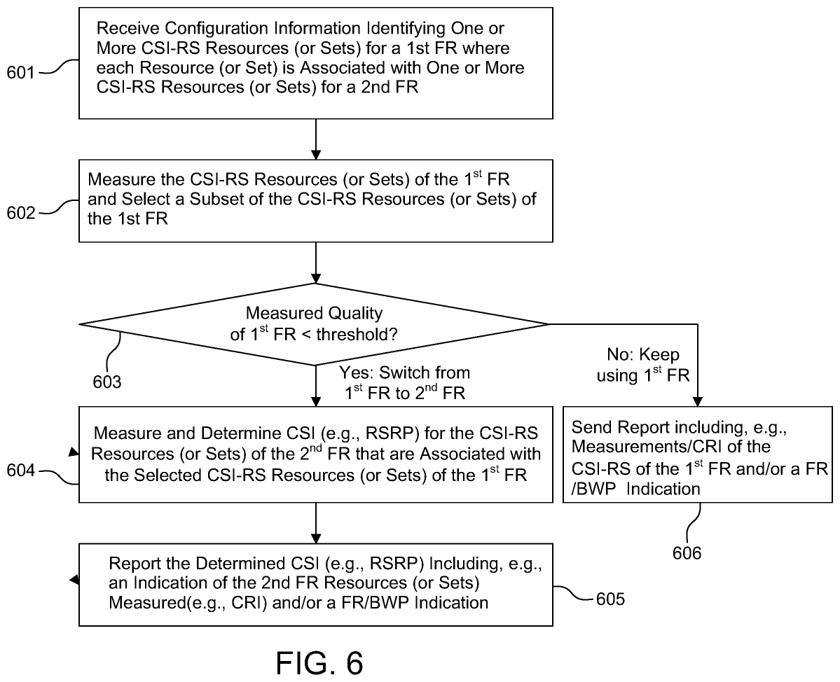

FIG. 6 is a flowchart depicting an example of a method for seamless switching between FRs as may be performed by a WTRU in a system (e.g., in accordance with the system of FIG. 5). As shown in FIG. 6, at 601, a WTRU may receive configuration information identifying one or more CSI-RS resources (or sets of CSI-RS resources) for a first FR where each resource or set of resources is associated with one or more CSI-RS resources or sets of resources for a second FR. In some cases, second FR may be a lower FR than the first FR. For example, the first FR may be in the frequency range of 52.6 GHz-71 GHz. The second FR may be, for example, a 28 GHz band. At 602, the WTRU may measure the CSI-RS resources (or sets of resources) of the first FR and select a subset of the CSI-RS resources (or sets of resources) of the first FR (e.g., the CSI-RS resources or sets of resources having the highest L1-RSRP). The measurements may be performed in accordance with a CSI report configuration configured for the first FR. At 603, the WTRU may determine whether the measurement for the first FR is less than a threshold value. For example, the determination may be based on whether a highest measurement quality (e.g., an L1-RSRP) of all the CSI-RSs in the first FR is less than a threshold.

If the measurement quality is less than the threshold value, the WTRU may switch operation from the first FR to the second FR. At 604, the WTRU may then measure and determine CSI (e.g., RSRP) for the CSI-RS resources (or sets of CSI-RSs) of the second FR that are associated with the selected CSI-RS resources (or sets of CSI-RSs) of the first FR. The measurements and reporting may be performed in accordance with the CSI report configuration configured for the second FR associated with the CSI report configuration for the first FR. At 605, the WTRU may report the determined CSI (e.g., RSRP) including an indication of the second FR resources (or sets of FR resources) measured (e.g., CRI) and possibly include an FR/BWP indication in the report.

If the measurement quality is not less than the threshold value, the WTRU may keep using the first FR. At 606, the WTRU may report measurements (e.g., CRI) of the CSI-RS of the first FR and possibly include an FR/BWP indication.

Embodiments implementing different modes of operation with independent CSI reports and CSI reports based on associations are described herein. One or more of modes of operation (e.g., independent CSI reports or CSI report based on associations) may be used CSI reporting. The number of configured CSI-RS resource sets for each purpose (e.g., channel measurement or interference measurement) may be determined based on a mode of operation determined, used, or configured. One or more of the following may apply. In some solutions, a mode of operation may be determined based on the number of configured CSI-RS resource sets per CSI report config for each purpose (e.g., channel measurement or interference measurement). For example, a WTRU may determine a mode of operation based on the number of configured CSI-RS resource sets for each purpose. If a nodeB configures a CSI-RS resource set per CSI report config (e.g., for channel measurement), the WTRU may determine to use an independent CSI report mode. If the nodeB configures more than one CSI-RS resource set per CSI report config (e.g., for channel measurement), the WTRU may determine to use CSI report mode based on associations.

In some solutions, a mode of operation may be determined based on the number of configured CSI-RS resources (e.g., beams) per CSI report config for each purpose (e.g., channel measurement or interference measurement). For example, a WTRU may determine a mode of operation based on the number of configured CSI-RS resources per CSI report config for each purpose. In some cases, for instance, if a number of the configured CSI-RS resources is smaller than (or equal to) X, the WTRU may determine to use an independent CSI report mode. If the number of the configured CSI-RS resources is larger than X, the WTRU may determine to use CSI report based on associations. In some circumstances, the X may be predefined and/or configured by a nodeB (e.g., a gNB).

In some solutions, a mode of operation may be determined based on a WTRU capability and nodeB configuration based on the WTRU capability reporting. For example, if a WTRU indicates one CSI-RS resource set (e.g., for channel measurement) per CSI report config as a WTRU capability, the WTRU may determine to use independent CSI report mode. If the WTRU indicates more than one CSI-RS resource set per CSI report config as a WTRU capability, the WTRU may determine to use CSI report based on associations. In some circumstances, the nodeB configuration can be performed based on the reported WTRU capability.

In some solutions, a WTRU may request its preferred mode of operation for CSI report modes. For example, if the WTRU is capable to support both modes of operation, the WTRU may indicate to a gNB for the preferred mode of operation. The WTRU may determine the preferred mode of operation based on one or more of following: a frequency range; a number of configured CSI-RS resources (e.g., beams) and/or CSI-RS resource sets (e.g., panels); a number of configured CORESET pools (e.g., TRPs); or a bandwidth for measurement.

Embodiments directed to CSI-RS resource, resource set, or report configuration associations among different FRs are described herein. In some solutions, a WTRU may be configured with at least two CSI report configurations. The WTRU may receive a first CSI report configuration for the first FR and a second CSI report configuration for to the second FR, which is associated with the first CSI report configuration. FIG. 3, introduced and discussed substantially in paragraphs above, provides an example of one system in which CSI-RS resources configured for different FRs are associated.

In some cases, considering the first FR (e.g., FR2) and the second FR (e.g., FR3), the first CSI report configuration may include a CSI-RS resource set for each purpose (e.g., channel measurement or interference measurement). The CSI-RS resource set may include one or more CSI-RS resources to be used in channel and/or interference measurements, where each CSI-RS resource of the first CSI-RS resource set of the first CSI report configuration may be associated with a CSI-RS resource set of the second CSI report configuration. The second CSI report configuration may include one or more CSI-RS resource sets, each including one or more CSI-RS resources to be used in channel and/or interference measurements

Alternatively, or additionally, a WTRU may be configured with one or more CSI report configurations. The one or more CSI report configurations may be used, configured, or determined, where the indication of the association between the CSI report configurations of the different FR may be based on one or more of an explicit indication or an implicit indication.

In some cases, such as in the case of an explicit indication, the CSI report configurations may explicitly indicate the CSI-RS resource(s), CSI-RS resource set(s), the periodicity and time offsets, CSI report quantity, and the codebook configuration for the first CSI report configuration and second CSI report configuration.

In some cases, such as in the case of an implicit indication, the CSI report configurations, CSI-RS resource(s) and CSI-RS resource sets for the second FR may be used, configured, or determined implicitly in association with the CSI report configurations, CSI-RS resource(s) and CSI-RS resource sets for the first FR. The implicit indication may be based on one or more of several parameters or features. In some cases, the implicit indication may be based on a CSI-RS resource/resource set association. For example, if the first FR belongs to lower frequency ranges than the second FR, one or more CSI resource sets, each including one or more CSI-RS resources, for the second FR may be selected so that they are a subset of the first FR's best CSI-RS Resources, e.g., the CSI-RS beams with the highest RSRP (e.g., the highest L1-RSRP).

As another example, if the first FR belongs to higher frequency ranges than the second FR, one or more CSI Resources for the second FR may be selected such that they include the best CSI-RS resources and the CSI-RS resource sets of the first FR, e.g., the CSI-RS beams with the highest L1-RSRP. As another example, an association between CSI-RS resources and CSI-RS resource sets may be based on the configured orders. For example, a WTRU may be configured with a first CSI report configuration with one or more CSI-RS resources and a second CSI report configuration with one or more CSI-RS resource sets. Based on the configured orders, the WTRU may determine the associations. For example, a first CSI-RS resource of the one or more CSI-RS resources of the first CSI report configuration may be associated with a first CSI-RS resource set of the one or more CSI-RS resource sets of the second CSI report configuration. In some examples, an association between CSI-RS resources and CSI-RS resource sets may be based on an indication received from a nodeB.

In some solutions the implicit indication may be based on a periodicity and slot offset association. For example, the first CSI report configuration may be configured with a CSI report (e.g., periodic or semi-persistent) for the first FR. And, the second CSI report configuration may be configured with a CSI report (e.g., semi-persistent or aperiodic) for the second FR, where the periodicity or the time offset in the CSI report configuration for the second FR may be a factor or a function of the periodicity in the associated CSI report configuration for the first FR. For example, the first CSI report configuration may be configured with a first one or more CSI-RS resources/resource sets (e.g., periodic or semi-persistent) for the first FR. And, the second CSI report configuration is configured with second one or more CSI-RS resources/resource sets (e.g., semi-persistent or aperiodic) for the second FR, where the periodicity or the time offset of the second one or more CSI-RS resources/resource sets for the second FR may be a factor or a function of the periodicity of the first one or more CSI-RS resources/resource sets in the associated first CSI report configuration for the first FR.

Embodiments involving CSI-RS measurement and reporting in association between different FRs are described herein. In some solutions, a WTRU may receive messaging or signaling with information providing one or more of a trigger, an activation or a configuration for both the first CSI report configuration and the second CSI report configuration, and the WTRU may report in one or more of several ways.

In some embodiments, the WTRU may report on more than one FR. When the WTRU reports first CSI based on the first CSI report configuration, the WTRU may determine and report a CSI-RS resource based on measurements of the one or more CSI-RS resources of the first CSI report configuration. When the WTRU reports second CSI based on the second CSI report configuration, the WTRU determines and reports a CSI-RS resource based on measurements of the one or more CSI-RS resources of the CSI-RS resource set of the second CSI report configuration that are associated with the CSI-RS resource of the first CSI. For example, the WTRU may indicate CSI for both FRs based on one or more of several metrics. Such metrics may include a CRI. For example, the WTRU may indicate a first CRI for the first FR (e.g., wider FR2 CSI beam) and a second CRI for the second FR (e.g., narrower FR3 CSI beam). The second CRI may be a delta CRI (e.g., indicating the index of the narrower beam within the wider beam). In another example, the WTRU may indicate a first CRI for the first FR (e.g., narrower FR3 CSI beam) and a second CRI for the second FR (e.g., wider FR2 CSI beam). The second CRI may be a delta CRI (e.g., indicating the index of the wider beam that encompass the narrower beam)

The metrics may include a CQI. For example, the WTRU may indicate a first CQI for the first FR (e.g., FR2) and a second CQI for the second FR (e.g., FR3). The second CQI may be indicated as a differential CQI feedback (e.g., the differential second CQI is computed based on the first CQI as the reference).

In some examples, the WTRU may indicate a first CRI for the first FR (e.g., narrower FR3 CSI beam) and a second CRI for the second FR (e.g., wider FR2 CSI beam). The second CRI may be a delta CRI (e.g., indicating the index of the wider beam that encompass the narrower beam)

In some embodiments, the WTRU may report on the preferred FR. In some solutions, a WTRU may determine a CSI report configuration based on a preferred FR and report CSI based on the determined CSI report configuration. For example, a WTRU may be configured with a first CSI report configuration associated with a first FR and a second CSI report configuration associated with a second FR. Based on the configurations, the WTRU may determine a FR of the first FR and the second FR. If the WTRU determines the first FR is a preferred FR, the WTRU may report CSI based on the first CSI report configuration. If the WTRU determine the second FR as a preferred FR, the WTRU may report CSI based on the second CSI report configuration.

The application of the CSI report based on a preferred FR may be different based on one or more of a CSI report type or a channel type for CSI reporting. For example, in some solutions, a CSI report based on a preferred FR may be supported for a first CSI report type (e.g., aperiodic and/or semi-static) and may not be supported for a second CSI report type (e.g., semi-static and/or periodic). In some examples, for an aperiodic CSI report, when an aperiodic CSI trigger indicates the first CSI report configuration and the second CSI report configuration simultaneously, the WTRU may determine a CSI report configuration of the first CSI report configuration and the second CSI report configuration and report CSI based on the determined CSI report configuration. In some examples, for a semi-static CSI report, when a WTRU receives an activation of the first CSI report configuration and the second CSI report configuration simultaneously (e.g., with association and/or a CSI report based on a preferred FR), the WTRU may determine a CSI report configuration of the first CSI report configuration and the second CSI report configuration and report CSI based on the determined CSI report configuration. For a CSI report configuration which is not determined, the WTRU may consider it as deactivated

In some solutions, CSI reporting based on a preferred FR may be supported for a first CSI channel type (e.g., PUSCH) and may not be supported for a second CSI report type (e.g., PUCCH). For example, for a CSI report with PUSCH, when a signal or message including information such as DCI triggers/activates the first CSI report configuration and the second CSI report configuration simultaneously (e.g., for aperiodic or semi-persistent CSI, the WTRU may determine a CSI report configuration of the first CSI report configuration and the second CSI report configuration and report CSI based on the determined CSI report configuration

The WTRU selection on the preferred FR may be based on one or more of CSI-RS measurements (e.g., channel quality) or a failure. As an example, in some solutions, the WTRU may measure the channel or interference for the first FR based on the first CSI report configuration, and the WTRU may measure the channel or interference for the second FR based on the second CSI report configuration. The WTRU may determine and report the preferred FR based on the measured quantities (e.g., CQI, L1-RSRP, L1-SINR).

In some solutions, the WTRU may determine and report the preferred FR based on configured thresholds that are configured for failure determination. The WTRU may determine FR3 as the preferred FR and report the CSI corresponding to FR3, if the measured quantity (e.g., CQI, RSRP, SINR) is higher than a threshold. The WTRU may determine FR1 or FR2 as the preferred FR and report the CSI corresponding to FR1 or FR2, if the measured quantity (e.g., CQI, RSRP, SINR) is lower than a threshold.

A WTRU may report the preferred FR based on one or more of an explicit indication or an implicit indication. The WTRU may report the preferred FR as a part of CSI report. An explicit indication may be based on one or more of following: a CSI report Configuration Indicator (CCI); a Frequency Range Indicator (FRI); or a Bandwidth Part Indicator (BPI). For an implicit indication, the WTRU may report the failure indication based on the uplink resources, wherein FR3 CSI report may be reported in FR3 resources and FR1 or FR2 CSI report may be reported in their corresponding FR1 or FR2 resources. The uplink resources may be one or more of a PUCCH, a PUSCH or a PRACH. In some solutions, the WTRU may report the FR1 or FR2 CSI report in the corresponding FR1 or FR2 resources following the FR3 resources to reduce blind decoding at the nodeB. As such, after determining a decoding failure in FR3 by a nodeB, the nodeB can try to decode CSI reporting in FR1 or FR2.

In some solutions, a WTRU may receive one or more of a trigger, an activation, or a configuration for a CSI report configuration for both FRs. For example, the WTRU may be configured with a CSI report configuration with a first CSI-RS resources/resource sets associated with a first FR and a second CSI-RS resources/resource sets associated with a second FR. Based on the configuration, the WTRU may determine a FR for CSI reporting and report the FR to a gNB. One or more of several procedures may then be performed.

In some procedures, a WTRU may determine the preferred FR based on one or more of CSI-RS measurements (e.g., channel quality), or based on a failure. As an example, the WTRU may measure the channel or interference for the first FR based on the first CSI report configuration, and the WTRU may measure the channel or interference for the second FR based on the second CSI report configuration. In some embodiments, the WTRU may determine and report the preferred FR based on the measured quantities (e.g., CQI, L1-RSRP, L1-SINR). As an example, the WTRU may determine and report the preferred FR based on configured thresholds that are configured for failure determination. The WTRU may determine FR3 as the preferred FR and report the CSI corresponding to FR3, if the measured quantity (e.g., CQI, RSRP, SINR) is higher than a threshold. The WTRU may determine FR1 or FR2 as the preferred FR and report the CSI corresponding to FR1 or FR2, if the measured quantity (e.g., CQI, RSRP, SINR) is lower than a threshold.

In some procedures, a WTRU may report the preferred FR based on one or more of an explicit indication or an implicit indication. In the case of an explicit indication, the WTRU may report the preferred FR as a part of CSI report. The indication may be based on one or more of the following: a FRI; a BPI; a CSI-RS Resource Set Indicator (CRI or CRSI); or a CSI-RS Resource Indicator (CRI).

In the case of an implicit indication, the WTRU may report the failure indication based on the uplink resources, wherein FR3 CSI report may be reported in FR3 resources and FR1 or FR2 CSI report may be reported in their corresponding FR1 or FR2 resources. The uplink resources may be one or more of a PUCCH, a PUSCH or a PRACH. In some solutions, the WTRU may report the FR1 or FR2 CSI report in the corresponding FR1 or FR2 resources following the FR3 resources to reduce blind decoding at the nodeB. As such, after determining a decoding failure in FR3 by a nodeB, the nodeB can try to decode CSI reporting in FR1 or FR2.

In some solutions, a WTRU may receive a trigger or activation for a CSI report configuration which may include a first CSI report quantity (e.g., CRI-RI-LI-PMI-CQI) associated with a first CSI-RS in a first FR (e.g., FR3) and a second CSI report quantity (e.g., CRI-RI-PMI-CQI or CRI-RI-i1) associated with a second CSI-RS in a second FR (e.g., FR1 or FR2).

As introduced above, FIG. 2 depicts an example of a CSI-RS PMI report in association with the FRs. In some examples, the first CSI report quantity may be associated with a first codebook configuration (e.g., Type-I codebook) and the second CSI report quantity may be associated with a second codebook configuration (e.g., Type-II codebook), as shown in FIG. 2.

A WTRU may determine which FR of the first FR and the second FR to use based on the measurement of the first CSI-RS and the second CSI-RS. Based on the determined FR, the WTRU reports CSI to a nodeB. The WTRU may report CSI based on the first CSI report quantity, the first codebook configuration and the first CSI-RS, if the WTRU determines the first FR. The WTRU may report CSI based on the second CSI report quantity, the second codebook configuration and the second CSI-RS, if the WTRU determines the second FR.

In a solution that may prevent blind decoding at the nodeB, the CSI report may include three parts. For example, the first part may include one or more FR indications (e.g., one or more of FRI, BPI, CRI and CRSI); the second part may include wideband information (e.g., one or more of CRI, RI, LI, wideband PMI and wideband CQI); and the third part may include subband information (e.g., subband PMI and subband CQI). In some solutions, the WTRU may decode a CSI report with the three parts based on, for example, the following operation.

For example, the WTRU may decode the first part to determine a FR for the CSI report. Based on the determined FR, the WTRU may determine a size of payloads (e.g., number of bits) for a second part. Based on the determined size of payloads for the second part, the WTRU may decode the second part to determine wideband information. For example, the WTRU may determine one or more of CRI, RI, LI, wideband PMI and wideband CQI. Based on the determined wideband information, the WTRU may determine a size of payloads (e.g., number of bits) for a third part. Based on the determined size of payloads for the third part, the WTRU may decode the third part to determine subband information. For example, the WTRU may determine one or more of subband PMIs and subband CQIs.

Methods for switching between FRs are described. The term FR may be interchangeably used with any of the terms BWP, carrier, cell, supplementary FR, supplementary downlink, supplementary cell and supplementary carrier but still remain consistent with these embodiments. Additionally, FR ID may be interchangeably used with BWP ID, carrier ID, cell ID, supplementary FR ID, supplementary downlink ID, supplementary cell ID and supplementary carrier ID but still remain consistent with these embodiments.

A WTRU may be configured with one or more FRs for its operation. In some solutions, based on the configuration, the WTRU may dynamically determine to use or to operate in a FR of the one or more FRs. The determination of the FR to use may be for one or more of the following operations: reception of channels and signals (e.g., Reception of one or more of PDCCH, PDSCH, CSI-RS, SSB (including PBCH), PRS, DM-RS and etc.); or transmission of channels and signals (e.g., transmission of one or more of PRACH, PUCCH, PUSCH, SRS, DM-RS and etc.).

Modes of operation with dynamic FR determination and semi-static FR determination are described herein. One or more of modes of operation (e.g., dynamic determination or semi-static determination) may be used for FR determination. The number (or the maximum number) of configured FRs may be determined based on a mode of operation determined, used, or configured. One or more of rules may apply for determining the mode. In some examples, a mode of operation may be determined based on the number of configured FRs for dynamic determination. For instance, a WTRU may determine a mode of operation based on the number of configured/indicated FRs. If a nodeB indicates/configures one FR, the WTRU may determine to use semi-static determination mode. If the nodeB indicates/configures more than one FRs, the WTRU may determine to use dynamic determination mode.

In some example, a mode of operation may be determined based on a WTRU capability and nodeB configuration based on the WTRU capability reporting. For instance, if a WTRU indicates one FR as a WTRU capability, the WTRU may determine to use semi-static determination mode. If the WTRU indicates more than one FRs as the WTRU capability, the WTRU may determine to use the dynamic determination mode. The nodeB configuration may be based on the reported WTRU capability.

In some examples, a WTRU may request its preferred mode of operation for FR determination. For instance, if the WTRU is capable of supporting both modes of operation, the WTRU may send an indication to a nodeB to express the preferred mode of operation. The WTRU may determine the preferred mode of operation based on one or more of a channel quality (e.g., CQI, RSRP, SINR, pathloss, probability of blockage and etc.) or traffic (e.g., amount of data to be received and/or transmitted).

In a first mode of operation (e.g., a semi-static determination mode), a WTRU may use an indicated or configured FR for processing one or more channels and/or signals. In a second mode of operation (e.g., a dynamic determination mode), a WTRU may determine a FR based on one or more of a nodeB indication, a WTRU request, or a combination of a nodeB indication and a WTRU report.

With respect to embodiments using a nodeB indication, in some solutions, a WTRU may receive an indication of an FR based on one or more of several parameters, signals or transmissions. Such parameters may include an indication of a an FR ID (or BWP ID). For example, the WTRU may be configured with a first FR with a first FR ID and a second FR with a second FR ID. Based on the configuration, the WTRU may receive an indication of an FR ID. If the WTRU receives an indication of the first FR ID, the WTRU may determine the first FR. If the WTRU receives an indication of the second FR ID, the WTRU may determine the second FR.

The indication may be based on a frequency direction. For example, the WTRU may be configured with a first FR located at a first carrier frequency and a second FR located at a second carrier frequency. Based on the configuration, the WTRU may receive an indication of a frequency direction. If the indication indicates higher frequency or lower frequency, the WTRU may determine a FR that is higher or lower than another FR.

The indication may be based on an FR type. For example, the WTRU may be configured with a first FR with a first FR type (e.g., normal FR) and a second FR with a second FR type (e.g., supplementary FR). If the WTRU receives an indication of the first FR type (e.g., normal FR), the WTRU may determine to use the first FR. If the WTRU receives an indication of the second FR type (e.g., supplementary FR), the WTRU may determine to use the second FR

The indication may be based on a TCI state. For example, the WTRU may be configured with a first TCI state associated with a first FR and a second TCI state associated with a second FR. If the WTRU receives an indication of the first TCI state (e.g., via one or more of DCI, MAC CE or RRC, or a logical equivalent), the WTRU may determine to use the first FR. If the WTRU receives an indication of the second TCI state, the WTRU may determine to use the second FR.

The indication may be based on a PDCCH transmission sent in a dedicated CORESET. For example, the WTRU may be configured with a first CORESET associated with a first FR and a second CORESET associated with a second FR. If the WTRU receives a PDCCH transmission via the first CORESET, the WTRU may determine the first FR. If the WTRU receives a PDCCH transmission via the second CORESET, the WTRU may determine the second FR

The WTRU may apply (or determine to use) a default FR before receiving the nodeB indication. The WTRU may determine the default FR based on one or more of a predefined FR, an RRC-configured FR (or an FR configured via a logical equivalent), or a WTRU requested FR. With respect to a predefined FR, the WTRU may determine a predefined FR to use before receiving the indication. The predefined FR may be one or more of following: a frequency location (e.g., the FR with lower frequency among the configured FRs); an FR ID (e.g., the FR with lowest or highest FR ID); an order of FR configuration (e.g., the FR with the firstly configured FR or the lastly configured FR); or an FR for initial access (e.g., the FR the WTRU initially accessed). With respect to an RRC-configured FR, the WTRU may be configured with a default FR (e.g., via RRC or a logical equivalent). With respect to a WTRU-requested FR, the WTRU may request to use its default FR (e.g., based on one or more of a PRACH, PUCCH or a PUSCH transmission).

The nodeB indication may be based on one or more of a DCI, a MAC CE, or another logically equivalent control message or signal. For example, a DCI may indicate that a FR of one or more configured/activated FRs may be used. In some cases, the WTRU may receive an activation message in a MAC CE. In some solutions, a MAC CE may indicate an FR of one or more configured/activated FRs may be used.

With respect to embodiments in which a WTRU request is used to indicate the FR to be used, in some solutions, a WTRU may request an FR to a nodeB based on one or more of explicit signaling (e.g., via one or more of PUCCH, PUSCH, MAC CE or PRACH transmissions); an associated uplink resource; or CSI reporting. With respect to explicit signaling, for example, the WTRU may be configured with one or more FRs. Based on the configuration, the WTRU may request the use of a FR of the one or more FRs. The indication may be one or more of an indication of FR ID (or BWP ID) or an indication of frequency direction.

With respect to an associated uplink resource, for example, the WTRU may be configured with a first uplink resource associated with a first FR and a second uplink resource associated with a second FR. If the WTRU transmits an uplink signal via the first uplink resource, the WTRU and the nodeB may determine to use the first FR. If the WTRU transmits an uplink signal via the second uplink resource, the WTRU and the nodeB may determine to use the second FR. The uplink signal may be one or more of a scheduling request; HARQ ACK/NACK; or a PRACH transmission.

With respect to CSI reporting, for example, the WTRU may be configured with a first configuration associated with a first FR and a second configuration associated with a second FR. Based on the configuration, one or more of following procedures or circumstances may apply. In some cases, the WTRU may report a preferred configuration of the first configuration or the second configuration. For example, if the WTRU reports the first configuration, the WTRU and the nodeB may determine the first FR. If the WTRU reports the second configuration, the WTRU and the nodeB may determine the second FR.

In some cases, the WTRU may send a first CSI report based on the first configuration and a second CSI report based on the second configuration. The WTRU and the nodeB may determine to use a FR based on the first CSI report and the second CSI report. For example, if a first channel quality of the first CSI report is lower than (or equal to) a second channel quality of the second CSI report, the WTRU and the nodeB may determine to use the second FR. If the first channel quality is higher than the second quality, the WTRU and the gNB may determine to use the first FR. The first channel quality and the second channel quality may be one or more of CQI, RSRP (e.g., an L1-RSRP), SINR (e.g., an L1-SINR), or pathloss.

In some cases, the first configuration and the second configuration may be one or more of a CSI report configuration; a CSI-RS resource; a CSI-RS resource set; an FR for CSI reporting; or a BWP for CSI reporting.

In some embodiments, the WTRU may receive a confirmation from a nodeB on the WTRU request. For example, the WTRU may receive a confirmation PDCCH transmission (e.g., via dedicated CORESET for nodeB confirmation and/or a MAC CE). After having the time gap (e.g., X symbols/slots/milliseconds) from the PDCCH reception (e.g., from a first/last symbol of PDCCH reception), the WTRU may apply the requested FR for the WTRU's operation.

In some embodiments, the WTRU may request an FR from a nodeB based on a combination of a nodeB indication and WTRU report. A combined method of nodeB indication and WTRU report may be supported. In some solutions, a WTRU may receive an indication of one or more FRs (e.g., via indicating a group of FRs) from a nodeB. Based on the indication, the WTRU may request a FR of the one or more FRs (e.g., via one or more of explicit signaling, associated uplink resource and CSI reporting). In some solutions, a WTRU may request one or more FRs (e.g., via one or more of explicit signaling, associated uplink resource and CSI reporting) to a nodeB. Based on the indication, the WTRU may receive an indication of a FR of the one or more FRs.

Embodiments directed to counters and timers for FR switching are described herein. In some solutions, a WTRU may apply a counter and/or a timer for FR switching. For example, the WTRU may be configured with a first FR, a second FR, and a counter and/or a timer. Based on the configuration, the WTRU may switch a FR based on the counter and/or the timer. For example, the WTRU may switch from the first FR to the second FR based on a determination (e.g., based on a nodeB indication and/or WTRU request). After the determination, the WTRU may apply the counter. For example, the WTRU may increase a value of the counter when the WTRU transmits/receives one or more transmissions and/or signals. If the value of the counter is smaller than (or equal to) a threshold, the WTRU may use the second FR. If the value of the counter is larger than the threshold, the WTRU may switch from the second FR to the first FR.

The initial value of the counter may be zero. The counter may reset when the WTRU switches FR. The counter and the threshold may be one or more of predefined, indicated (e.g., via MAC CE and/or DCI or another logical equivalent) and configured via RRC signaling or another equivalent.

In some examples, the WTRU may switch from the first FR to the second FR based on a determination (e.g., based on nodeB indication and/or WTRU request). After the determination, the WTRU may apply the timer. If the timer does not expire, the WTRU may use the second FR. If the timer expires, the WTRU may switch from the second FR to the first FR. The timer may be one or more of predefined, indicated (e.g., via MAC CE and/or DCI or another logical equivalent) and configured via RRC signaling or another equivalent.

The transmission/reception of the one or more channels and/or signals may include one or more of reception of channels and signals (e.g., reception over one or more of PDCCH, PDSCH, CSI-RS, SSB (including PBCH), PRS, or DM-RS) or transmissions of channels and signals (e.g., transmission over one or more of PRACH, PUCCH, PUSCH, SRS, DM-RS).

Embodiments directed to frequency range switching mechanisms for power saving are described herein. A WTRU may be configured, be determined to operate, or use one or more power saving mode when one or more frequency ranges are used. A frequency range may be interchangeably used with FR, carrier, cell, virtual cell, frequency band, bandwidth part (BWP), subband, and frequency resource. A frequency range or a frequency band may be referred to by, for example, a lower or upper frequency bound of the frequency range or band, or a center frequency of the frequency range or band. In such case, the frequency range or frequency band may be further defined by a bandwidth that spans the usable spectrum of the range or band.

A first power saving mode (e.g., WTRU power saving) may be a normal mode in which a WTRU may perform transmission/reception of a signal in each FR based on a configuration for the FR. For example, a first configuration for a first FR may determine the WTRU transmission/reception behavior in the first FR and a second configuration for a second FR may determine the WTRU transmission/reception behavior in the second FR. In some cases such as these, there may be no association between FRs for power saving. A second power saving mode may be a power saving mode in which a WTRU may perform transmission/reception of a signal in a first FR based on one or more conditions in an associated FR (e.g., second FR).

In some solutions, a power saving mode for one or more FRs may be determined based on at least one of several characteristics. For example, the power saving mode may be determined based on a beam association between the FRs. For example, if a beam in a first FR is associated with one or more beams in a second FR, a second power saving mode may be used; otherwise, a first power saving mode may be used. A beam association may be at least one of a quasi co-location (QCL) association between reference signals in different FRs or an association between beams for control channels in different FRs (e.g., a beam for a first CORESET in a first FR may be QCL-ed with a beam for a second CORESET in a second FR).

The power saving mode may be determined based on a power saving signal configuration. For example, if a power saving signal is configured (or a WTRU is configured to monitor for a power saving signal), a second power saving mode may be used; otherwise, a first power saving mode may be used. The power saving signal may be a signal that indicates whether a WTRU has to wake up to monitor a PDCCH if the WTRU was not already in a state for monitoring the PDCCH (e.g., DRX, OFF-duration). The power saving signal may be referred to as a wake-up-signal (WUS). A signal indicating whether a WTRU should to skip monitoring of the PDCCH for a certain time window (or, in some cases, should skip monitoring of the PDCCH until it receives an indication to do so) may be referred to as a go-to-sleep signal (GTS). A signal may also indicate whether a WTRU has to change its DRX (or C-DRX) configuration. A power signal may be indicated, transmitted, sent, provided, or informed via one or more higher layers (RRC, MAC-CE, or another logical equivalent), a sequence, and/or DCI.

The power saving mode may be determined based on a frequency range (or frequency range combination) that is used or configured. For example, if FR1 and FR2 are used or configured, a first power saving mode may be used or determined; if FR2 and FR3 are used or configured, a second power saving mode may be used or determined.

When a WTRU is configured with multiple frequency ranges (e.g., configured with FR2 and FR3 for transmission/reception of a signal), the WTRU may perform one or more of several procedures in a power saving mode. In some embodiments, the WTRU may perform autonomous activation/deactivation of a FR. For example, one or more states (e.g., active, inactive, dormant) may be used for a FR and if one or more conditions are met in a first FR, the WTRU may activate a second FR if the second FR is in inactive state. One or more of following WTRU behaviors may be used based on the state of an FR. If an FR is in active state, a WTRU may monitor one or more PDCCH search spaces and perform measurement in the FR. If an FR is in inactive state, a WTRU may not perform PDCCH search space monitoring and measurement (e.g., RRM, RLM, and/or CSI). If an FR is in dormant state, a WTRU may not perform PDCCH search space monitoring; but the WTRU may perform measurements (e.g., RRM, RLM, and/or CSI). A WTRU may activate a second FR (e.g., FR2) if the WTRU determines a beam failure has occurred in a first FR (e.g., FR3), wherein beam failure may be referred to as the case where one or more beam quality metrics (e.g., an RSRP) of a CORESET beam in an FR is lower than a threshold. When the second FR is activated (or in active state), the WTRU may deactivate the first FR (or determine the first FR in inactive state)

In some embodiments, the WTRU may send a cross-FR power saving signal indication. For example, a power saving signal for a first FR may be received, monitored, or indicated in a second FR. A WTRU may monitor power saving signal for a first FR in a second FR when the first FR is in a first state (e.g., inactive) while the second FR is in a second state (e.g., active or dormant).

In some embodiments, the WTRU may fall back to a default FR. For example, a WTRU may fall back to a first FR (e.g., a default FR, a FR with a lower frequency, or FR2) when one or more following conditions are met for the second FR. A WTRU may fallback when the WTRU performs transmission/reception of a signal in a default FR and stops performing transmission/reception in all other FRs. Fallback may be performed, for example, when: a beam failure is determined for a FR; when a WTRU has not received a control signal (e.g., DCI) for a certain time window; when a mobility metric of a WTRU (e.g., WTRU speed or rotation) is higher than a threshold; when a preferred beam for a control channel (e.g., CORESET) changes faster than a threshold, which may be determined by a WTRU (and indicated to a nodeB). When a timer expire (for example, if a timer may start and run when a WTRU does not receive a control signal (e.g., DCI) in a slot, the timer may be reset when the WTRU receives a control signal in a slot); or when a remaining battery level of a WTRU. For example, if WTRU's battery level is below a threshold, the WTRU may fall back to a default FR and deactivate all other FRs.

In some embodiments, the WTRU may report an FR state. For example, a WTRU may report the mode of operation to a nodeB. For example, if the WTRU falls back to a default FR and deactivates some or all other FRs, the WTRU may report, to a nodeB, the state of each FR (or current default FR, or fallback mode of operation).

Embodiments directed to Hierarchical Spatial Relation for beam indication are described herein. Solutions described in the following paragraphs may enable efficient beam indication for a WTRU operating in multiple frequency ranges characterized by different beam widths.

Some solutions may enable configuration of a parent beam resource. In the following, a beam resource may be referred to by a TCI state, a CSI-RS or an SSB for downlink beams, or an SRS resource or TCI state for uplink beams. A beam resource may be identified by a beam indication. In some solutions, a WTRU may be configured with first and second sets of beam resources, where a beam resource of the second set may be associated with at least one beam resource of the first set. The at least one associated beam resource of the first set may be referred to as a “parent” or “fallback” beam resource. The beam resource of the second set may be in a different frequency range (e.g. higher frequency range) than its parent beam resource of the first set. The association may be configured such that the WTRU may operate simultaneously (e.g. receive PDCCH or PDSCH transmissions or send PUCCH or PUSCH transmissions) using a beam resource of the second set in a second frequency range and using its parent beam resource of the first set in a first frequency range. More than one beam resource of the second set may be associated with a same beam resource of the first set. This may physically correspond to a larger beam width for the beam of the first set.

In the case a beam resource is a TCI state, the configuration of a TCI state may include information concerning the at least one parent TCI state. Such information may include a serving cell identity, a bandwidth part identity and a TCI state identity for each parent TCI state. FIG. 4, introduced and described substantially in paragraphs above, depicts an example of a system in which signals transmitted in different FRs have a defined spatial relationship, or in other words, have associated TCI states, such as when a TCI state configured for a first FR is a parent TCI state and a TCI state configured for a second FR is a child TCI state associated with the parent.

Solutions involving groups of beam resources are described herein. The WTRU may be configured with at least one group of beam resources. A group of beam resources may include at least one beam resource of the first set and at least one beam resource of the second set, where the at least one beam resource of the first set may be associated with the at least one beam resource of the second set. The group of beam resources may be configured with a beam group identity. The group may contain indications of serving cell identities and bandwidth part identities for each beam resource of the group. The group configuration may include indications for each beam resource of whether that beam resource may be configured for PDCCH reception, PDSCH reception, PUSCH transmission, PUCCH transmission or a combination thereof. At least for a beam resource that may be configured for PDCCH reception, a CORESET identity may also be included.

Embodiments directed to TCI state activation/deactivation are described herein. A WTRU may receive signaling indicating activation and/or deactivation of at least one TCI state for PDSCH reception or PUSCH transmission. Such signaling may be performed via MAC CE. The following solutions may allow for more efficient signaling when the number of TCI states configured for the WTRU is very large.

Implicit activation/deactivation of TCI states may be based on parent TCI states. In some solutions, the WTRU may implicitly determine an activation/deactivation state for a TCI state based on the activation/deactivation state of the at least one parent TCI state. The WTRU may determine that a TCI state is activated if at least one of its parent TCI states is activated. The WTRU may determine that a TCI state is deactivated if all its parent TCI states are deactivated. Such determination may occur upon reception of a MAC CE indicating activation/deactivation state for at least one parent TCI state. If the WTRU receives signaling explicitly indicating activation/deactivation state for a TCI state, it may apply such state irrespective of the activation/deactivation state of parent TCI states.

In some solutions, the WTRU may implicitly determine an activation/deactivation state for a TCI state based on whether at least one parent TCI state is configured or indicated as TCI state for PDCCH for at least one serving cell identity or coreset identity. The WTRU may receive such an indication by a MAC CE or a logical equivalent. The indication may be a TCI state indication for WTRU-specific PDCCH transmissions or MAC CEs.

The WTRU may also receive a MAC CE indicating at least one TCI group identity, at least one serving cell identity and at least one CORESET identity for a PDCCH. The WTRU may apply a first TCI state of the group for PDCCH reception in the indicated serving cell identity and CORESET identity. The first TCI state may be a TCI state identified as parent TCI state within the group or a TCI state identified for PDCCH reception within the group. The WTRU may activate alone or more TCI states of the group for PDSCH reception, PUSCH transmission or PUCCH transmission. The WTRU may deactivate some or all TCI states not configured in the group.

Embodiments providing for indication of sets of TCI states corresponding to a parent TCI state are described herein. In some solutions, the WTRU may receive a MAC CE, or a logical equivalent, indicating an activation/deactivation state for only the set of TCI states for which a parent TCI state is an indicated TCI state. The MAC CE may include an indication of a parent TCI state including a serving cell identity, a bandwidth part identity and/or a TCI state identity. The MAC CE may further include a bitmap where each bit corresponds to a TCI state for which a parent TCI state is the indicated parent TCI state. The bit order may be determined by a serving cell identity first, bandwidth part identity second and TCI state identity last, or a permutation or derivation thereof. The set of TCI states indicated by the bitmap may be restricted to TCI states of a certain serving cell identity and/or bandwidth part identity, which may be indicated in the MAC CE.

Embodiments providing for indication of a TCI state based on a parent TCI state are described herein. In some solutions, the WTRU may determine a size of a field (e.g., a DCI field and/or MAC CE field) for a TCI state indication based on one or more of a configured number of the parent TCI states or a maximum configured number of TCI states among candidate TCI states. With respect to a configured number of the parent TCI states, the WTRU may determine a size of field based on the determined parent TCI state. For example, if the parent TCI state comprises X (e.g., 8) TCI states for the indication, the WTRU may determine Y (e.g., 3) bits for the indication. For example, Y=log₂ (X).

With respect to a maximum configured number of TCI states among candidate TCI states, the WTRU may determine a size of field based on the configured candidate TCI states for one parent TCI states. For example, if a first candidate TCI state, for a parent TCI state, is associated with M TCI states and a second candidate TCI state, for parent TCI state, is associated with N TCI states, the WTRU may determine L bits for the indication. For example, if M is smaller than (or equal to) N, the WTRU may determine L based on N (e.g., L=log₂(N)). If M is larger than N, the WTRU may determine L based on M (e.g., L=log₂(M)). Based on the parent TCI state, the WTRU may receive one or more padding bits for the TCI state indication. For example, if M is larger than N and the second candidate TCI state (e.g., with N associated TCI states) is the parent TCI state, then one or more padding bits may be attached or appended to the front or the end of the TCI state indication.

Embodiments for indicating activation/deactivation for a group of TCI states are described herein. In some solutions, the WTRU may receive a MAC CE or a logically equivalent indication of an activation/deactivation state for a set of TCI states configured in a group of TCI states. The group of TCI states may be as described in the above paragraphs for the group of beam resources. The MAC CE may include an indication of the TCI state group identity and an indication of the activation/deactivation state of each TCI state of the group, possibly using a bitmap. The MAC CE may also include an indication of a serving cell identity and/or bandwidth part identity of the TCI states for which activation/deactivation state is signaled. In such cases, only TCI states with a corresponding serving cell identity and/or bandwidth part identity may be included in the bitmap.

Embodiments for indicating a group of TCI states for PDCCH reception are described herein. In some solutions, the WTRU may receive a MAC CE or a logically equivalent message indicating a group of TCI states applicable for PDCCH reception for at least one serving cell identity and/or at least one CORESET identity. The MAC CE may contain an identity of a group of TCI states. For at least one TCI state of the group, the WTRU may apply this TCI state for reception of PDCCH transmissions for a serving cell identity and CORESET identity. The at least one TCI state of the group may be TCI state(s) identified for PDCCH reception as part of the group configuration. The serving cell identity and/or CORESET identity may be configured for each of the at least one TCI state as part of the group configuration. Alternatively, or additionally, at least one serving cell identity and/or CORESET identity may be included in the MAC CE.

Embodiments directed to cross-carrier scheduling are described herein. A WTRU may receive a PDCCH transmissions in a CORESET of a first serving cell, the PDCCH transmission containing scheduling information for a second serving cell. The PDCCH transmission may be received using a first TCI state configured for the corresponding coreset. The PDCCH transmission may carry DCI that includes a TCI field indicating a second TCI for reception of a PDSCH transmission or transmission of PUSCH or PUCCH.

In some solutions, the mapping between each value of the TCI field and a TCI state identity may depend on the first TCI state configured for PDCCH reception in the coreset. More specifically, the TCI field may indicate one of a set of TCI states for which a parent TCI state corresponds to the first TCI state. In some cases, the set may be restricted to TCI states that are activated based on MAC signaling.

Embodiments directed to indicating a group of beam resources and beam resources within a group are described herein. In some solutions, a WTRU may determine an applicable beam resource for at least one of reception of PDCCH, reception of PDSCH, transmission of PUCCH, transmission of SRS, transmission of PRACH and/or transmission of PUSCH from the identity of a group of beam resources and the identity of a beam resource within the group.

The WTRU may receive information indicating the identity of a group of beam resources in a DCI, MAC CE, RRC signaling or a logical equivalent of the same. In some instances, the identity may also be implicitly derived from a property of a grant or assignment. The identity may be applicable to only a transmission signaled by the same PDCCH implicitly or explicitly indicating the identity. Alternatively, or additionally, the identity of the group may remain applicable to transmissions and receptions until it is modified by new signaling. In case the WTRU does not receive information indicating the identity of a group of beam resources, it may apply a default group of beam resources. Such default group may be configured by higher layers, possibly from system information.

The WTRU may receive an identity of a beam resource within the group explicitly indicated by a field such as TCI field (e.g. for PDSCH or PUSCH) or SRS identity, or implicitly based on a property of the grant or assignment. For each group of beam resource and for each serving cell and/or bandwidth part, a default beam resource may be configured. The WTRU may apply a default beam resource for a transmission or reception in a serving cell and/or bandwidth part if it is not provided an identity of a beam resource within the group.

Embodiments directed to Quasi Co-Location (QCL) and spatial relationships for downlink, uplink, and both downlink and uplink are described herein. In some methods, a WTRU may receive configuration information that indicates that a specified group of FR3 beams are collocated spatially with another FR2 beam. The WTRU may receive configuration information that indicates a QCL relationship between a resource set for a downlink reference signal and DM-RS ports of the PDSCH, the DM-RS port of a PDCCH, the CSI-RS port(s) of a CSI-RS resource or the PRS port for a PRS reference signal.

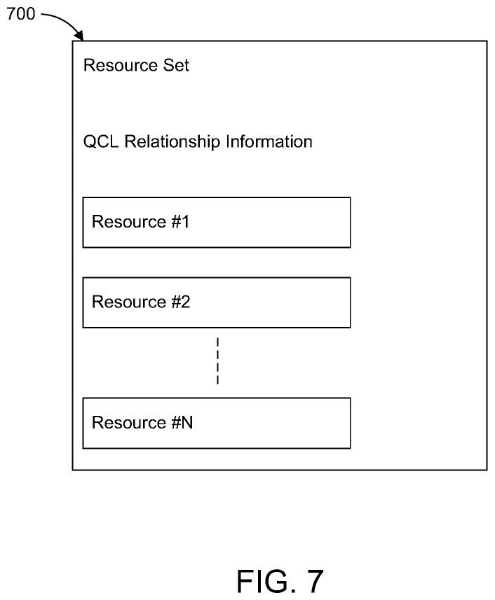

FIG. 7 depicts an example of QCL relationship information for a resource set. In some cases, a WTRU may determine to apply the same QCL relationship across the resources in the resource set. For example, as illustrated in FIG. 7, a WTRU may receive configuration information 700 indicating QCL relationship information associated with resources of a resource set of a reference signal. In such case, the WTRU may determine, based on the received configuration information, to apply the QCL relationship to N resources in the resource set such as when monitoring the configured resources to receive downlink signals.

For example, a WTRU may be configured with QCL relationship type D for a resource set which may refer to a resource, and which may be referred to as the reference resource here. The WTRU may determine that all resources in the resource set have a QCL type D relationship with the reference resource. For example the reference resource may be an FR2 beam and all resources in the resource set may be FR3 beams, i.e., all resources in the resource set which have the QCL type D relationship with the reference resource may be spatially collocated. Thus, the WTRU may determine to use the same spatial domain filter to receive the source RS or channel to receive any of the reference signals corresponding to the resources in the resource set which is in QCL relationship with the source RS or channel.

In this disclosure, the terms “corresponding” or “correspondence” and “associating” or “association” may be used interchangeably. The WTRU may receive configurations indicating QCL relationships for resource set and resources in the resource set, QCL relationships between a resource set and ports of downlink reference signals, and/or QCL relationships between resources in the resource set and ports of downlink reference signals.

In some cases, the WTRU may determine to switch between spatial domain filters as in the following paragraphs. For example, the WTRU may switch between a spatial domain filter used to receive the downlink reference signal which has a QCL relationship with the resource set and spatial domain filters used to receive the downlink reference signals which is in QCL relationship with the resource in the resource set. The condition to switch between spatial domain filters may depend on at least one of beam failure or an RSRP of a received reference signal. In case of beam failure, the WTRU may determine to use the spatial domain filter used to receive the downlink reference signal which is in QCL relationship with the resource set. In the case an RSRP of received reference signal is below the predetermined threshold, the WTRU may determine to use the spatial domain filter used to receive the downlink reference signal or channel which has the QCL relationship with the resource set. If RSRP is above the threshold, the WTRU may determine to use the spatial domain filter used to receive the downlink reference signal or channel that has the QCL relationship with any of the resources in the resource set.

The QCL relationship may be any of a QCL-TypeA, QCL-TypeB, QCL-TypeC or a QCL-TypeD relationship. For uplink, the WTRU may receive configuration information for a spatial relationship between a resource set for a uplink reference signal and DL reference signal or channel such as CSI-RS, SSB, SRS or PRS. The reference signals in the spatial relationship may be identified by a reference ID. In this case, the WTRU may determine to apply the spatial relationship to the resources in the resource set. For example, if the WTRU receives a configuration containing information which indicates a spatial relationship between a SRS resource set (target SRS resource set) and a CSI-RS resource (reference RS), the WTRU may determine that all SRS resources in the resource set and the CSI-RS resource have the same relationship. Thus, the WTRU may transmit one or more SRSs corresponding to any of the resources in the target SRS resource set using the same spatial domain filter as the spatial domain filter used for receiving the CSI-RS corresponding to the reference CSI-RS resource. The WTRU may transmit one or more SRSs corresponding to any of the resources in the target SRS resource set using the same spatial domain filter as the spatial domain filter used for receiving the CSI-RS corresponding to the reference CSI-RS resource.

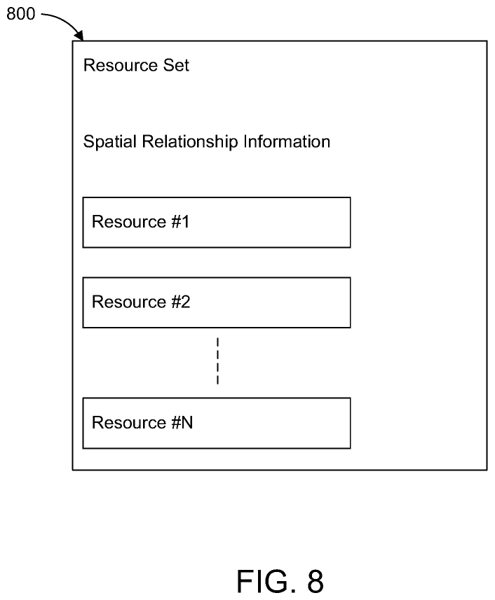

FIG. 8 depicts an example of spatial relationship information for a resource set. The WTRU may receive configuration information 800 indicating both a spatial relationship (e.g. a QCL indication) for a resource set and resources 1-N in the resource set. The spatial relationship or relationships may be between a resource set and a downlink reference signal or between one or more resources in the resource set and one or more downlink reference signals. In such a case, the WTRU may determine to switch between one of several spatial domain filters for transmission of an uplink reference signal. For example, the WTRU may switch between a spatial domain filter used to receive a downlink reference signal that has a spatial relationship with the resource set and spatial domain filters used to receive one or more downlink reference signals that have a spatial relationship with one or more resources in the resource set. The condition to switch between spatial domain filters may depend on at least one of beam failure or an RSRP of a received reference signal. In the case of beam failure, the WTRU may determine to use the spatial domain filter used to receive the downlink reference signal that has a spatial relationship with the resource set. If an RSRP of a received reference signal is below a predetermined threshold, the WTRU may determine to use the spatial domain filter used to receive the downlink reference signal that has a spatial relationship with the resource set. If an RSRP is above the threshold, the WTRU may determine to use the spatial domain filter used to receive a downlink reference signal that has a spatial relationship with any of the resources in the resource set. The benefits gained from the above methods may include reduction in the overhead required for signaling.

Embodiments directed to inheritance of behavior from a hierarchical spatial relationship are described herein. In some methods, a WTRU may receive configuration information that indicates that a specified group of FR3 beams are collocated spatially with another FR2 beam, and behavior of the FR2 beams can be applied to the group of FR3 beams, thus reducing the overhead required for signaling.

If a QCL or spatial relationship is configured in the resource set, the WTRU may assume the same beam behavior can be applied to all resources in the resource set inherently. For example, if the CSI-RS, which is used as the reference resource in the QCL relationship configured in the target CSI-RS resource set, is transmitted periodically from the nodeB, the WTRU may determine that all CSI-RS resources in the target CSI-RS resource set are also transmitted periodically. The WTRU may determine that periodicities of the transmission for CSI-RS resources in the target CSI-RS resources set may be scaled according to at least one of several parameters. Such parameters may include, for example, a numerology assumed for the target resource set. For example, the target CSI-RS resource set may be configured for FR3 and the source CSI-RS resource is configured in FR2. The parameters may include a number of resources in the target resource set, or an order of modulation in the target resource set.

Likewise, if the reference resource is configured a as semi-static or aperiodic reference signal the WTRU may determine that all resources in the target resource set are configured as semi-static or aperiodic reference signals, respectively. A benefit gained from the above methods may include a reduction in overhead required for signaling.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-20. (canceled)

21. A method performed by a wireless transmit/receive unit (WTRU), the method comprising:
receiving configuration information identifying one or more channel state information (CSI) reference signal (CSI-RS) resources in a first frequency range (FR), wherein at least one of the CSI-RS resources in the first FR is associated with one or more CSI-RS resources in a second FR and the second FR is a lower FR than the first FR;
measuring a signal quality of the one or more CSI-RS resources in the first FR;
selecting a subset of the one or more CSI-RS resources in the first FR;
on a condition the measured signal quality of at least the selected subset of the one or more CSI-RS resources in the first FR is lower than a threshold:
measuring a respective signal quality of each of the one or more CSI-RS resources in the second FR that are associated with the selected subset of the one or more CSI-RS resources in the first FR; and
sending a report including one or more of: the respective signal quality for each of the CSI-RS resources in the second FR that are associated with the selected subset of CSI-RS resources in the first FR; or an indication of the one or more CSI-RS resources in the second FR that are associated with the selected subset of the one or more CSI-RS resources in the first FR.

22. The method of claim 21, wherein the report includes an identifier associated with the second FR.

23. The method of claim 21, wherein the report includes an identifier associated with a bandwidth part (BWP) of the selected subset of the one or more CSI-RS resources.

24. The method of claim 21, wherein the reported signal quality of each of the one or more CSI-RS resources [symbol] in the second FR that are associated with the selected one or more CSI-RS resources in the first FR is a reference signal received power (RSRP).

25. The method of claim 21, wherein the first FR is between 52.6 GHz and 71 GHz.

26. The method of claim 21, wherein the second FR is a 28 GHz band.

27. The method of claim 21, wherein the selected subset of the one or more CSI-RS resources in the first FR has a highest measured signal quality among the one or more CSI-RS resources in the first FR.

28. The method of claim 21, wherein the report is a second report, and wherein the method comprises, on a condition the measured signal quality of at least the selected subset of the one or more CSI-RS resources in the first FR is not lower than the threshold, sending a first report including the measured signal quality of the selected subset of the one or more CSI-RS resources in the first FR.

29. The method of claim 21 comprising:
communicating with a base station using a beam that is quasi-co-located (QCLed) with a subset of the one or more CSI-RS resources in the first FR;
determining, based on the measured signal quality of the one or more CSI-RS resources in the first FR, to switch from the first FR range to the second FR; and
communicating with the base station using another beam that is QCLed with the one or more CSI-RS resources in the second FR that are associated with the selected one or more CSI-RS resources in the first FR.

30. The method of claim 29, wherein the beam that is QCLed with the subset of the one or more CSI-RS resources in the first FR is wider than the another beam that is QCLed with the one or more CSI-RS resources in the second FR that are associated with the selected one or more CSI-RS resources in the first FR.

31. A wireless transmit/receive unit (WTRU) comprising:
a processor; and
a transceiver;
the transceiver configured to receive configuration information identifying one or more channel state information (CSI) reference signal (CSI-RS) resources in a first frequency range (FR), wherein at least one of the CSI-RS resources in the first FR is associated with one or more CSI-RS resources in a second FR and the second FR is a lower FR than the first FR;
the processor and the transceiver configured to measure a signal quality of the one or more CSI-RS resources in the first FR;
the processor configured to select a subset of the one or more CSI-RS resources in the first FR;
on a condition that the measured signal quality of at least the selected subset of the one or more CSI-RS resources in the first FR is lower than a threshold:
the processor and the transceiver are configured to measure a respective signal quality of each of the one or more CSI-RS resources in the second FR that are associated with the selected subset of the one or more CSI-RS resources in the first FR; and
the processor and the transceiver are configured to send a report including one or more of: the respective signal quality for each of the CSI-RS resources in the second FR that are associated with the selected subset of CSI-RS resources in the first FR;
or an indication of the one or more CSI-RS resources in the second FR that are associated with the selected subset of the one or more CSI-RS resources in the first FR.

32. The WTRU of claim 31, wherein the report includes an identifier associated with the second FR.

33. The WTRU of claim 31, wherein the report includes an identifier associated with a bandwidth part (BWP) of the selected subset of the one or more CSI-RS resources.

34. The WTRU of claim 31, wherein the reported signal quality of each of the one or more CSI-RS resources in the second FR that are associated with the selected one or more CSI-RS resources in the first FR is a reference signal received power (RSRP).

35. The WTRU of claim 31, wherein the first FR is between 52.6 GHz and 71 GHz.

36. The WTRU of claim 31, wherein the second FR is a 28 GHz band.

37. The WTRU of claim 31, wherein the selected subset of the one or more CSI-RS resources in the first FR has a highest measured signal quality among the one or more CSI-RS resources.

38. The WTRU of claim 31, wherein the report is a second report, and wherein the method comprises, on a condition the measured signal quality of at least the selected subset of the one or more CSI-RS resources in the first FR is not lower than the threshold, sending a first report including the measured signal quality of the selected subset of the one or more CSI-RS resources in the first FR.

39. The WTRU of claim 31, wherein the processor and the transceiver are configured to communicate with a base station using a beam that is quasi-co-located (QCLed) with a subset of the one or more CSI-RS resources in the first FR;
the processor and the transceiver are configured to determine, based on the measured signal quality of the one or more CSI-RS resources in the first FR, to switch from the first FR range to the second FR; and
the processor and the transceiver are configured to communicate with the base station using another beam that is QCLed with the one or more CSI-RS resources in the second FR that are associated with the selected one or more CSI-RS resources in the first FR.

40. The WTRU of claim 39, wherein the beam that is QCLed with the subset of the one or more CSI-RS resources in the first FR is wider than the another beam that is QCLed with the one or more CSI-RS resources in the second FR that are associated with the selected one or more CSI-RS resources in the first FR.
